(19) United States
(12) Patent Application Publication
(10) Pub. No.: US 2008/0205970 A1
(43) Pub. Date: Aug. 28, 2008

(54) TOOTHBRUSH WITH INTEGRATED TOOTHPASTE DELIVERY

(75) Inventors: Roger J. LaFlamme, Enfield, CT (US); Jim F. Warner, Westfield, NJ (US)

Correspondence Address: BARLOW, JOSEPHS & HOLMES, LTD., 101 DYER STREET, 5TH FLOOR, PROVIDENCE, RI, 02903, US

(73) Assignee: POLY-D, LLC, Torrington, CT (US)

(21) Appl. No.: 12/035,666

(22) Filed: Feb. 22, 2008

Related U.S. Application Data
(60) Provisional application No. 60/891,323, filed on Feb. 23, 2007.

(51) Int. Cl. B43K 5/00; A46B 11/04; B67D 5/16; A46B 9/04

(52) U.S. Cl. 401/205; 401/280; 401/270; 222/71; 15/167.1

(57) ABSTRACT

A toothpaste dispensing toothbrush is provided that includes a main body that contains a bladder therein that serves to contain a volume of toothpaste. A metered dosing pump is included that controls the flow of toothpaste from the fluid storage region and through a conduit that exits adjacent the bristles of the toothbrush head. Each operation of the metered dosing pump dispenses a measured and controlled amount of toothpaste into the bristles of the toothbrush. In addition to providing a flow of toothpaste, the rear side of the toothbrush may also include an additional “flavor burst” pack module to deliver an additional flavoring or another material, such as fluoride, to the flow of toothpaste.

### CROSS-REFERENCE TO RELATED APPLICATIONS

This application is related to and claims priority from earlier filed U.S. Provisional Patent Application No. 60/891,323 filed Feb. 23, 2007.

### BACKGROUND OF THE INVENTION

The present invention relates generally to product packaging and/or containers that include integrated dispensing devices. More specifically, the present invention relates to device that allows the user to introduce a metered dose of fluid in a controlled fashion into or onto the surface of the bristles of an integrated toothbrush.

Various types of fluid material and media are employed for different purposes throughout commerce and industry. For example, there are various products in the areas of personal care, home care, air care, transportation care and food industries that require a fluid material to be dispensed in some manner from a source of such material. Further, when this material is sold in commerce, it must be contained and stored in some type of container while awaiting use. Ultimately, when that product is used, it must be dispensed from its storage container to the desired location for use.

In the prior art, there are many different types of dispensers that are employed for the delivery of such a stored fluid material to its desired location for use. For example, a storage container having a flexible body with a nozzle tip extending therefrom is commonly provided for such a purpose. An example of such use can be seen in the context of a ketchup dispenser, where a user squeezes the container body to urge the fluid material (ketchup) out from container body and through the nozzle tip to accurately deposit the fluid material at the desired location. In such an application, the amount of fluid that is ultimately delivered is determined by the how much the user actually squeezes the container body. While this method has provided marginally acceptable results, this method also typically yields an erratic fluid volume since more or less fluid material may be delivered on each successive squeeze of the container body. Also, the container must be held upright to avoid leakage because no valves are employed in the fluid nozzle tip.

In another example of a prior art dispensing device, a flexible container is provided that holds a volume of fluid material to be delivered. In an attempt to overcome the leakage issue noted above, a single one-way check valve is provided at the exit port of the flexible container. When the flexible body is squeezed, the material is urged out under pressure through the valve. The difficulty here is that the valve, over time, becomes partially clogged thereby requiring that the user apply additional pressure to cause the valve to open. As a result, once the valve opens, the additional pressure causes more fluid material to be deposited than the user typically would have desired.

In addition to the controlled dispensing issue identified above, there is a desire in the art not only to simply dispense the fluid material but also to help apply it, such as to a surface. In the prior art, the solution to such an application was the provision of squeezable container bodies that are equipped with some type of applicator head for this purpose. For example, in the personal care industry, body wash devices commonly include some type of squeezable container body and an applicator material, such as fabric or foam, applied thereon. Thus, when the fluid material is dispensed to the outside of the container body, the applicator assists in spreading the material on the body of the user by spreading the fluid within the applicator for better and more even distribution thereof. Applicators are particularly useful for even distribution in personal care industry, such as shoe polish, hair colorant, shampoos and toothbrushes to ensure a quality even and smooth delivery of the material to the desired surface.

However, rather than relying simply on gravity or capillary flow to control the dispensing of the fluid material from the fluid reservoir to the applicator, it is desirable to have the fluid injected into the applicator, onto the applicator or be directed immediately under the porous surface of the applicator in a metered dosed fashion.

Accordingly, there is a need for a fluid container that provides a selective dosing mechanism that is easy to operate. There is a further need for a device that can dispense fluid materials in a metered fashion where the dispersion of the fluid can be controlled. There is still a further need of a device that includes an internal reservoir for storing fluid therein while also including a means for dispensing the fluid into an applicator in a controlled and metered fashion in order to produce predictable flow and a better control of the fluid material application. Many of these needs are met by commonly owned, co-pending U.S. patent application Ser. No. 11/074,817, filed on Mar. 8, 2005 and U.S. patent application Ser. No. 11/951,351, filed on Dec. 6, 2007, which are incorporated herein by reference. There is still a further need for an effective device that can dispense fluid materials, such as toothpaste, to the teeth of a user in a metered and dosed fashion where the flow of the liquid can be controlled.

### BRIEF SUMMARY OF THE INVENTION

In this regard, the present invention preserves the advantages of prior art liquid dispensers that are capable of dispensing toothpaste and the like. In addition, the present invention provides new advantages not found in currently available devices while overcoming many of the disadvantages identified above that are inherent in the currently available devices.

The present invention is generally directed to a novel and unique applicator device that also includes an integrated fluid dispenser. In particular, in the context of this invention, the fluid dispenser serves to dispense a fluid such as toothpaste into an applicator brush for use in brushing the user's teeth. It should be appreciated that many different types of fluids may be dispensed using the present invention and toothpaste is one example that will be discussed in detail herein. However, the example provided is intended to be illustrative and this invention shall not be considered to be limited to the dispensing of toothpaste in a tooth-brushing environment. In other words, it is envisioned that while the present invention has particular use in connection with tooth brushing, it also has other applications. All of these uses are within the scope of the present invention.

Generally, the toothpaste dispensing toothbrush of the present invention includes a main body that contains a bladder or fluid storage region therein. The fluid storage region in turn serves to contain a volume of toothpaste. An important feature of the present invention is the provision of a metered dosing pump that controls the flow of toothpaste from the fluid storage region and through a conduit that exits adjacent the bristles of the toothbrush head. The metered dosing pump mechanism employed within the present invention is substantially similar to that found in the above noted U.S. patent application Ser. Nos. 11/074,817 and 11/951,351. A metering housing, having a preferably flexible construction, is disposed in fluid communication with the fluid storage region and a first one-way valve is disposed between the fluid storage region and the flexible metering housing. When the flexible metering housing is depressed and released a vacuum action generates a one-way flow from the interior fluid storage region of the device that serves to fill the predetermined volume of the chamber within the metering housing. A second valve, in fluid communication with the metering housing output port, permits one-way fluid flow from the metering chamber to the toothbrush bristles when the metering housing is depressed again. Each time the metering housing is depressed a substantially equal volume of fluid is dispensed into the toothbrush bristles, while upon release, the metering housing is refilled by drawing fluid from the fluid storage region.

While a fluid storage region and a metered dosing pump is provided within the main body of the toothbrush of the present invention, it should be appreciated that the functional shape of the toothbrush is maintained so that the added features do not interfere with the operation thereof. To facilitate dispensing of the fluid it is preferred that a region of no bristles or a reduced number of bristles is provided at the exit of the fluid conduit to form a reservoir space within the toothbrush bristles for receipt of the dispensed toothpaste.

In addition to providing a flow of toothpaste, the rear side of the toothbrush may also include an additional “flavor burst” pack module to deliver an additional flavoring or another material, such as fluoride, to the flow of toothpaste. It is envisioned that the additional pack is a self-contained module, having an outer skin with the additional material contained therein that is snapped into a recess in the toothbrush. The module may include its own metered dosing pump that engages with a complementary fluid delivery conduit on the toothbrush. Alternatively, the recess in the toothbrush may include a pin that pierces the module to permit the additional material to flow to the head with the toothpaste from the bladder. The module can be easily popped out and replaced with a different module depending on the desires of the user.

In view of the foregoing, a new and unique toothbrush, with an integrated toothpaste dispenser, is provided. The new toothbrush facilitates the integrated delivery of toothpaste in a metered and dosed manner while providing an attractive appearance that is maintained throughout the use of the product.

It is therefore an object of the present invention to provide a fluid dispensing device that can transfer a substantially equal volume of fluid in the form of toothpaste from a fluid storage region to the bristles of a toothbrush with each dispensing operation. It is a further object of the present invention to provide a device that can dispense fluid materials in a metered fashion where the dispersion of the fluid can be controlled. It is still a further object of the present invention to provide a toothbrush that includes an internal reservoir for storing at least one fluid therein while also including a means for dispensing the fluid into the bristles thereof in a controlled and metered fashion.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a perspective view of the toothbrush of the present invention;

FIG. 2 is a cross sectional view of the toothbrush of the present invention taken along line 2-2 of FIG. 1;

FIG. 3 is a perspective view of an alternate embodiment toothbrush of the present invention;

FIG. 4 is a cross sectional view of the toothbrush of the present invention taken along line 4-4 of FIG. 3; and

FIG. 5 is a cross sectional view of an alternate embodiment dispensing pump of the invention.

### DETAILED DESCRIPTION OF THE INVENTION

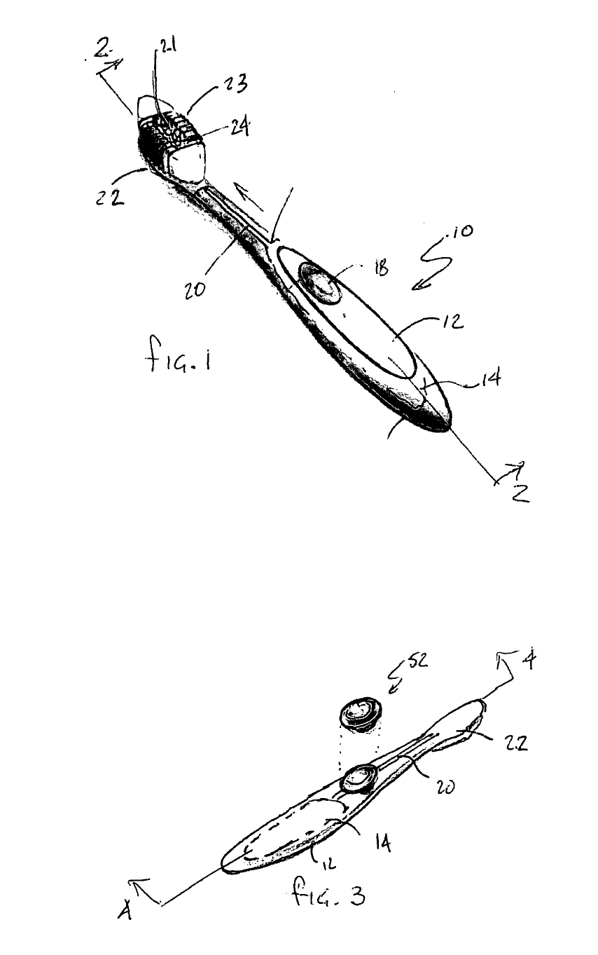

Now referring to the drawings, the toothbrush with integrated dispenser of the present invention is shown and generally illustrated at 10 in FIG. 1. As was stated above, the present invention is generally directed to a novel and unique applicator device in the form of a toothbrush 10 that also includes an integrated fluid dispenser. In particular, in the context of this invention, the fluid dispenser serves to dispense a fluid such as toothpaste into an applicator brush for use in brushing the user's teeth. Further, while toothpaste is disclosed herein, it should be appreciated that many different types of fluids may be dispensed using the present invention and toothpaste is one example that will be discussed in detail herein. However, the example provided is intended to be illustrative and this invention shall not be considered to be limited to the dispensing of toothpaste in a tooth-brushing environment. In other words, it is envisioned that while the present invention has particular use in connection with tooth brushing, it also has other applications. All of these uses are within the scope of the present invention.

Generally, the toothpaste dispensing toothbrush 10 of the present invention includes a main body 12 that has a hollow cavity therein that serves to contain a bladder or fluid storage region 14. The fluid storage region 14 in turn contains a volume of fluid 16 such as toothpaste. In addition, the toothbrush 10 can be seen to include a metered dosing pump 18 that controls the flow of toothpaste 16 from the fluid storage region 14 and through a conduit 20 that exits an output port 21 adjacent the toothbrush head 22. The operation of the metered dosing pump 18 will be discussed in detail below. Further, the toothbrush 10 can be seen to include a plurality of bristles 23 extending outwardly from the head 22 for use in cleaning the user's teeth. To facilitate dispensing of the fluid 16 it is preferred that a region of no bristles or a reduced number of bristles 24 is provided at the exit 21 of the fluid conduit 20 to form a reservoir space within the toothbrush 10 bristles 23 for receipt of the dispensed toothpaste 16. Further, it should be appreciated that while a fluid storage region 14 and a metered dosing pump 18 is provided within the main body 12 of the toothbrush 10 of the present invention, the functional shape of the toothbrush 10 is maintained so that the added features do not interfere with the operation thereof.

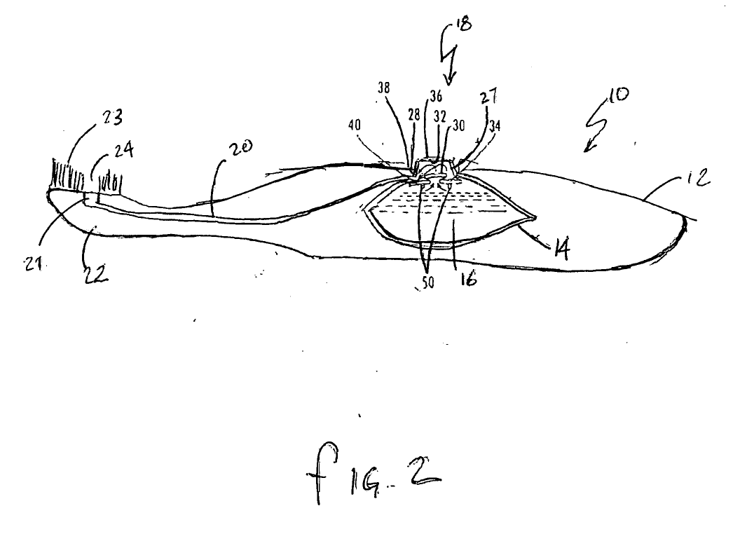

Turning now to FIG. 2, a cross section of the fluid dispensing toothbrush 10 of the present invention is shown. In this view it can be seen that the fluid dispensing toothbrush 10 includes a fluid storage region 14 that is positioned within the main body 12. The fluid storage region 142 is configured as a reservoir for containing a fluid 16 such as toothpaste. Further, a metered dosing pump 18 is provided in fluid communication with the fluid storage region 14. The metered dosing pump 18 is selectively operable to deliver, upon actuation by the user, a measured amount of the toothpaste 16 contained therein. Still referring to FIG. 2, the internal construction of the metering pump 18 in relation to the fluid storage region 14 the toothbrush 10 of the present invention is shown. The fluid storage region 14 contains a volume of toothpaste 16 therein. The outer wall of the fluid storage region 14 is preferably made of a flexible material, such as plastic or nylon. Thus, as fluid material 16 is evacuated from within the fluid storage region 14, it will collapse gradually for a compact structure. It should also be appreciated that the fluid storage region 14 may be replaceable or refillable after all of the fluid 16 is removed therefrom.

The metering pump 18 is in fluid communication with the fluid storage region 14. The metering pump 18 includes a metering housing 27 is provided at a first opening 28 in the fluid storage region 14. The metering housing 27 includes an intake one-way valve 30, such as a check valve, to pull fluid 16 from the fluid storage region 14 into the metering chamber 32 of a predetermined size. Any type of valve can be used to suit the given application. The intake valve 30 is positioned in a base plate 34 of the metering housing 27. Thus, fluid 16 can only flow in one way from the fluid storage region 14 into the metering chamber 32. The metering chamber 32 is defined by a flexible membrane 36 in the form of a button or bulb that is accessible and manipulatable on the exterior surface of the main body 12 of the device 10. The button 36 is preferably clear to provide an indicator to the consumer when the metered dosage of fluid material 16 is ready for delivery. An output valve 40 is provided in fluid communication with the metering chamber 32 of the metering housing 27. Thus, the fluid residing in the metering chamber 32 can only exit through the output valve 40. Also, a fluid conduit 20 is provided to direct the exit of the fluid 16. In this particular case to an opening 21 in the head 22 of the toothbrush 10 adjacent the bristles 23. In accordance with the present invention, each press of the flexible membrane 36 causes a metered amount of fluid 16 to be forced through the opening 21 to provide the desired measured dosing application. This button/membrane 36 can be placed anywhere on the device, as needed.

Still referring to FIG. 2, the operation of the metered dosing pump 18 is further explained. The button 36 of the metering housing 27 is depressed to initiate a vacuum operation. More specifically, when the button 36 is further released, fluid 16 is pulled from the fluid storage region 14 into the metering chamber 32 which is configured to be of a certain known volume. The act of releasing the button 36 fills the metering chamber 32 to substantial capacity. Thus, a metered amount of fluid material 16 is contained within the metering chamber 32 in preparation for delivery. The size of the metering chamber 32 can be selected according to the type of fluid material 16 to be dispensed, the application therefor and the desired dosage volume. A further depression of the button 36 urges the measured volume of fluid 16 within the metering chamber 32 to exit out through the output valve 40 of the metering housing 27. This known amount of fluid material 16 is then routed into through the fluid conduit 20 and out through the opening 21 in the toothbrush 10 head 22.

In most cases, the fluid 16 is then deposited onto the rear of the bristles 23 although it is also within the scope of the present invention to route the fluid conduit 20 so that the fluid 16 is deposited into the bristles 23 or onto the front surface of the bristles 23.

It can also be seen in FIG. 2 that a number of standoff legs 50 emanate downwardly from the base plate 34 of the metering housing 27. These legs 50 prevent the base plate 34 from completely bottoming out against the walls of the fluid storage region 14 thereby blocking flow of fluid material 16 into the intake valve 30. The standoff legs 50 are particularly useful when the volume of fluid material 16 left in the fluid storage region 14 is running low and the fluid storage region 14 is becoming relative flat in configuration. In this situation, there is a possibility that the aforesaid bottoming out may occur. However, the use of the standoff legs 50 prevents this from occurring. It should also be appreciated that while standoff legs 50 are shown, other spring biased or spring like structures may be used to accomplish the same function and should be considered interchangeable with the standoff legs 50.

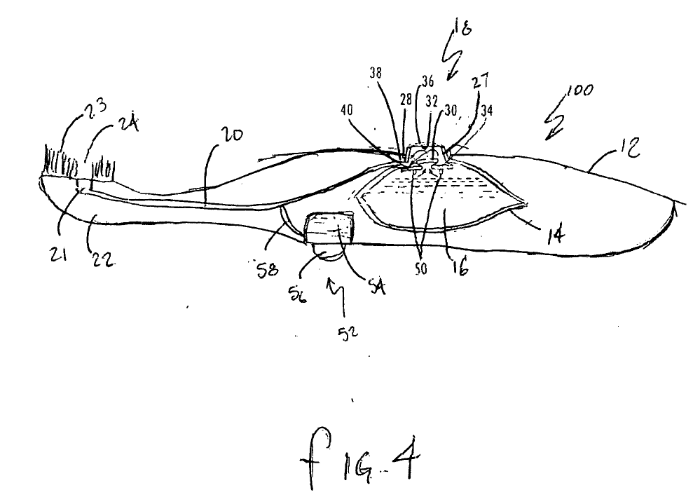

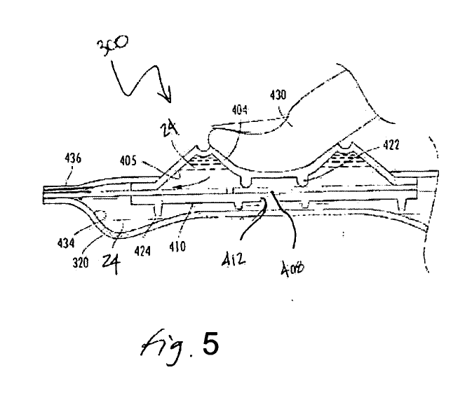

Turning now to FIGS. 3 and 4, an alternate embodiment toothbrush 100 is shown that in addition to providing a flow of toothpaste 16, the rear side of the toothbrush 100 may also include an additional “flavor burst” pack module 52 to deliver an additional flavoring 54 or another material, such as fluoride, to the flow of toothpaste. It is envisioned that the additional pack 52 is a self-contained module, having an outer skin with the additional material 54 contained therein that is snapped into a recess in the toothbrush 100. The module 52 may include its own metered dosing pump 56 that engages with a complementary fluid delivery conduit 58 on the toothbrush 100. Alternatively, the recess in the toothbrush 100 may include a pin that pierces the module 52 to permit the additional material 54 to flow to the head 22 with the toothpaste 16 from the fluid storage region 14. The module 52 can be easily popped out and replaced with a different module 52 depending on the desires of the user.

At FIG. 5, details are shown of an alternate metering pump 300 that includes the improved valving of the present invention that prevents inadvertent or accidental dispensing of fluid 16 even when pressure is placed on the pump 300 or the fluid storage region 320. FIG. 5 illustrates intentional dispensing of fluid 16. When it is desired to actually dispense the liquid product 16, the user's thumb 430 can depress the flexible dome 404. By application of force against the stand-off legs 424, such that flexible dome 404, with the assistance of the stand-off legs 422 under the flexible dome, securely seals and provides a positive lock of the flapper valve 408 over and about the aperture 412 thereby closing the liquid flow passage back into the reservoir 434 of the fluid reservoir 320. Other fingers of the user may be used to carry out this operation. Thus, the only path for the liquid 302 contained within the cavity 405 of dome 404 is to exit through the one-way outlet valve 436 for intended dispensing of the product, as indicated by the arrows.

It should be understood that the stand-off legs 422 on the bottom of the flexible dome housing 404 and the stand-off legs 424 on the bottom of the base plate 410 can be modified in size, length and configuration to adjust the amount of squeezing necessary by the user's fingers 430, 432 to effectuate sealing of the flapper valve 408. For example, preferably four standoff legs 422 are provided on the bottom of the flexible dome housing 404 in a 2×2 array and can be 1/32 of an inch in length. It is also possible that these standoff legs 422 can be a single downwardly depending wall, such as in the shape of a circle or square. Such an array is configured to downwardly press against the one-way flapper valve 408 outside of the diameter of the aperture 412 through the base plate 410 to provide a good seal of the flapper valve 408 to the base plate 410.

In view of the foregoing, a new and unique toothbrush, with an integrated toothpaste dispenser, is provided. The new toothbrush facilitates the integrated delivery of toothpaste in a metered and dosed manner while providing an attractive appearance that is maintained throughout the use of the product.

It would be appreciated by those skilled in the art that various changes and modifications can be made to the illustrated embodiments without departing from the spirit of the present invention. All such modifications and changes are intended to be covered by the appended claims.

What is claimed:

1. A toothbrush, comprising:
a main body having a fluid storage region therein, a head at one end thereof;
a metering pump in fluid communication with the fluid storage region and having at least one exit port adjacent the head, wherein depression of the metering pump urges fluid from the fluid storage region through the exit port; and
bristles disposed at the head about the at least one exit port.

2. The toothbrush of claim 1, the metered pump further comprising:
a flexible metering housing, having a metering chamber therein with a predetermined volume and a metering housing output port, the metering housing in fluid communication with the fluid storage region;
a first valve disposed between the fluid storage region and the flexible metering housing to permit unidirectional fluid flow from the fluid storage region into the metering chamber thereby filling the predetermined volume of the metering chamber; the flexible metering housing further including;
a second valve, having a second valve output port, in fluid communication with the metering housing output port and permitting unidirectional fluid flow of a volume of fluid substantially equal to the predetermined volume of the metering chamber from the metering chamber via the second valve output port.

3. The toothbrush of claim 1, wherein the at least one exit port directs the fluid onto a top end of the bristles.

4. The toothbrush of claim 1, wherein the at least one exit port directs the fluid into a void formed between the bristles.

5. The toothbrush of claim 1, wherein the at least one exit port is a plurality of exit ports formed in the head.

6. The toothbrush of claim 1, wherein the fluid is toothpaste.

7. The toothbrush of claim 1, wherein the fluid storage region is refillable.

8. The toothbrush of claim 1, wherein the fluid storage region is replaceable.

9. The toothbrush of claim 1, further comprising:
an auxiliary fluid module containing an auxiliary fluid and having a output port, wherein the auxiliary fluid module is removably connected to the toothbrush body and removably in fluid communication with the flow of fluid to the exit port.

10. The toothbrush of claim 9, further comprising:
a second metering pump in fluid communication with the auxiliary fluid module and having a pump exit port in fluid communication with the flow of fluid to the exit port, wherein depression of the second metering pump urges fluid from the auxiliary fluid module into the flow of toothpaste.

11. The toothbrush of claim 9, wherein the auxiliary fluid is a flavored liquid.

12. The toothbrush of claim 9, wherein the auxiliary fluid is fluoride.
